(19) United States
(12) Patent Application Publication
(10) Pub. No.: US 2018/0008090 A1
(43) Pub. Date: Jan. 11, 2018

(54) FOOD PROTECTION DEVICE

(71) Applicant: Charles Collins Garrison, JR., Katy, TX (US)

(72) Inventor: Charles Collins Garrison, JR., Katy, TX (US)

(21) Appl. No.: 15/204,843

(22) Filed: Jul. 7, 2016

(51) Int. Cl. A47J 36/24; A21D 17/00

(52) U.S. Cl. CPC A47J 36/24; A21D 17/004

(57) ABSTRACT

A device and method for the protection of food when cooking or reheating in an oven type cooking device is illustrated and described. The food protection device includes a lower member configured to provide support and elevation to the food. Apertures are optionally located in the lower member. A heat shield is in communication with the lower member and is configured to reflect heat to ensure even cooking of the food. The heat shield is configured to extend over a portion of the lower member. The heat shield regulates the amount of heat applied directly to the food between the heat shield and the lower member. Optionally, the heat shield may be modified in shape by the user and/or selectively interchanged so as to customize the cooking effects upon the food.

### BACKGROUND

### 1. Field of the Invention

The present application relates to a device for reheating food, and more particularly to a specifically shaped device for pizza slices.

### 2. Description of Related Art

It appears as though most people prefer food to be cooked or heated for consumption. Naturally this line of thought does not apply equally to all types of food. There are some foods meant to be served cold or at natural/ambient temperatures. A large amount of food we prepare needs to be cooked or heated to make it suitable for consumption. Also, where food was once cooked, it is common for people to desire it to be reheated when consumed at a later time. The issue arises as to how best to cook or reheat selected types of food.

Typical reheating devices are microwave ovens and toaster ovens. Individual servings of the food to be reheated are placed into the device and subjected to a heating method. Food can react differently in each type of device. For example, in a toaster oven, heated coils extend over a food product and apply heat. In a microwave, the food is subjected to radio waves at selected frequencies to agitate water molecules in food. Toaster ovens can tend to re-cook the food and do so unevenly.

For example, when dealing with pizza, the crust portion and a toppings portion are at different heights. The crust tends to be higher than toppings portion and therefore closer to the heated coils in a toaster oven. This close proximity can lead to the crust being over cooked in comparison to the toppings portion. Crusts often get burned in an attempt to adequately cook the toppings portion.

There does not appear to be a product that can adequately ensure the proper and even cooking/reheating of a pizza slice to compensate for the varied height levels between the crust and topping portions. It is desired that a device be developed to allow for the even reheating and cooking of a pizza slice in a cooking device to avoid damage to the food. Although great strides have been made in cooking/reheating devices, shortcomings remain.

### SUMMARY OF THE INVENTION

The present application discloses a device that is used in the cooking and/or reheating of food. The food ideally used is food that has an uneven or stepped upper surface wherein the food surfaces are at varied distances from a heating element. Ideally this is seen most commonly in cooking devices, such as toaster ovens, broilers, conventional oven units, pizza ovens and so forth where the food is in close proximity to a heating element (i.e. heating coil, gas heating unit, and so on). However this is understood not to be an exhaustive listing of the various cooking devices and heating elements.

The system is a food protection device having a lower member configured to provide support and elevation to a food product. The lower member is useful in raising the food off the racks used in a cooking device. The device further includes a heat shield in communication with the lower member. The heat shield is configured to reflect heat generated from one or more heating elements. As food often includes an uneven surface where one portion is significantly higher/thicker than another, the heat shield is designed to prevent the thicker portions from being exposed to too much heat and burning prior to the other food portions. The heat shield is configured to extend over a portion of the lower member. Furthermore, the heat shield regulates the amount of heat applied directly to the food between the heat shield and the lower member.

In some embodiments, the lower member may include one or more apertures. This may be done via a mesh material. The lower member can assist in allowing for the circulation of heat around the perimeter of the food. The shape of the protection device is adjustable in that it may be manufactured to any shape and size. As seen in the figures, the protection device is shown with respect to a pizza slice. Other embodiments may allow for the interchangeability of the heat shield to allow the user to customize the amount of heat reflection.

The more important features of the protection device have thus been outlined in order that the more detailed description that follows may be better understood and to ensure that the present contribution to the art is appreciated. Additional features of the device will be described hereinafter and will form the subject matter of the claims that follow.

Many objects of the present device will appear from the following description and appended claims, reference being made to the accompanying drawings forming a part of this specification wherein like reference characters designate corresponding parts in the several views.

Before explaining at least one embodiment of the device in detail, it is to be understood that the device is not limited in its application to the details of construction and the arrangements of the components set forth in the following description or illustrated in the drawings. The system is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present system. It is important, therefore, that the claims be regarded as including such equivalent constructions insofar as they do not depart from the spirit and scope of the present system.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a food protection device according to an embodiment of the present application.

FIG. 2 is an enlarged exemplary view of a lower member of the food protection device of FIG. 1.

FIG. 3 is a bottom view of the food protection device of FIG. 1.

FIG. 4 is a top view of the food protection device of FIG. 1.

FIG. 5 is a side view of the food protection device of FIG. 1.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The device and method in accordance with the present application overcomes one or more of the above-discussed problems commonly associated with traditional heating/reheating methods for food. In particular, the device is configured to selectively cover portions of the food that is in closer proximity to a heating element than other portions in an effort to allow for an even heating/reheating/cooking effect upon the food. A user may interchange portions of the device to affect the degree of heat transfer through the device. These and other unique features of the device are discussed below and illustrated in the accompanying drawings.

The device and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The device and method of the present application is illustrated in the associated drawings. The device includes a lower member configured to provide support and elevation to the food. The lower member is designed to rest upon the rack or tray of the oven type heating/cooking device (i.e. an oven styled unit). Furthermore the device includes a heat shield in communication with the lower member. The heat shield is configured to reflect a predetermined amount heat energy to allow food portions closer to heating elements within the cooking device to cook at the same rate as other portions of the food. Additional features and functions of the device are illustrated and discussed below.

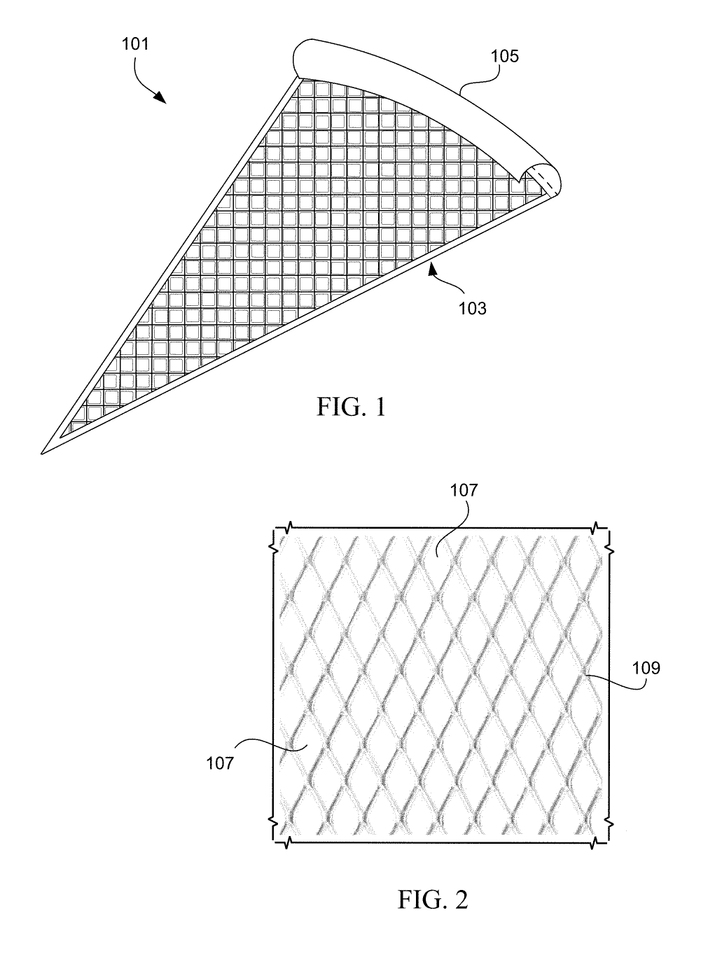

Referring now to the drawings wherein like reference characters identify corresponding or similar elements in form and function throughout the several views. FIG. 1 in the drawings illustrates a perspective view of the food protection device 101 according to an embodiment of the present application. Device 101 is configured to regulate the amount of heat energy reaching selected portions of food when subjected to heat energy within a cooking unit. Cooking units often have heating elements or gas heating units which may be close in proximity to the food. Where food is too close, burning may occur and/or cooking rates may vary. Device 101 is configured to regulate the heat energy to the food to ensure even cooking rates and minimize burning by shielding away amounts of heat energy from portions of the food.

As seen in FIG. 1, device 101 includes a lower member 103 and a heat shield 105. Member 103 is configured to elevate the food off the surface of the cooking unit (i.e. an oven, toaster oven, pizza oven, etc. . . . ). The heat shield 105 is in communication with member 103 and is configured to reflect a level of heat energy. Shield 105 extends over a portion of member 103 so as to cover a portion of the food.

Referring now also to FIG. 2 in the drawings, an enlarged view of lower member 103 is illustrated. Member 103 includes one or more apertures 107. Apertures 107 are designed to allow heat energy direct exposure to the food. Use of apertures 107 may increase the feel and taste of the food. Examples include making a crust more crispy or giving a desired appearance. Apertures 107 may come in different sizes. As seen in FIG. 2, a mesh 109 is illustrated in particular. Apertures 107 are seen as the void space between the mesh 109. Apertures 107 may be holes formed in any of a plurality of different methods. Additionally, apertures 107 are not limited to holes but may be shaped as rectangles, slots, channels and so forth.

Other embodiments of lower member 103 may forgo the use of apertures 107. Member 103 does not require apertures 107 to operate as intended herein. Member 103 may be a solid member and/or non-porous. For example, member 103 may be a sold stone material, a metallic sheet, or polymer based/composite material.

Heat shield 105 is coupled to a portion of member 103. Heat shield 105 is contoured to extend over a portion of member 103. This area is determined based upon the type of food being heated/cooked. As seen in the Figures, the illustrations closely resemble that of a pizza slice. The crust portion of the pizza slice would be placed between the heat shield 105 and member 107. The topping portion would rest outside of shield 105 across member 103. It is understood that device 101 may be sized and shaped differently, therefore the illustrations are not meant to be limiting to only operating with pizza slices. Member 103 may be shaped in any desired shape and size. Additionally, shield 105 may also be shaped and sized as desired. Device 101 is configured to allow for the user to selectively cover a portion of food with shield 105 so as to regulate the effects of over exposure to heat.

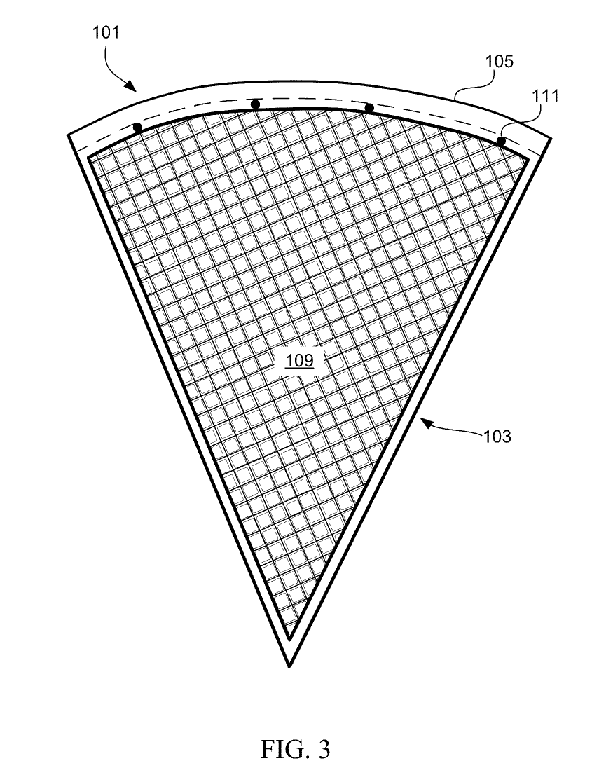

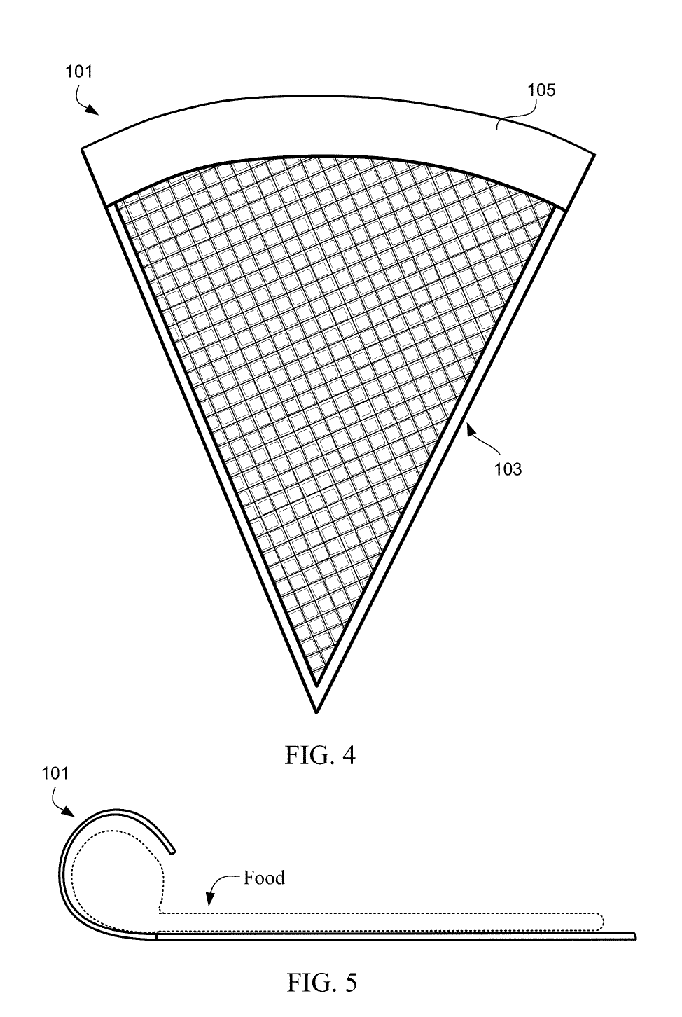

Referring now also to FIGS. 3-5 in the drawings, selected views of device 101 is illustrated. Mesh 109 is seen in FIGS. 3 and 4 along member 103. A border is applied around the periphery to cover the edges. The apertures of the mesh are useful in helping to allow for a more uniform and quicker cooking time. Shield 105 extends from the border of member 103 and wraps over an end of member 103. As seen in FIG. 5, a pizza slice is illustrated. Shield 105 is designed to extend over the crust portion of the slice. Shield 105 reflects a predetermined level of heat energy produced by the heating elements of the cooking device. Modifications to shield 105 may allow a user to choose the amount of heat energy to be reflected. In this way, an alternate embodiment of device 101 may permit for the interchangeability of shield 105. Shield 105 may interchange through any of a snap, a slot and hook, a latch, or any other fastening device. Fastening device 111 is illustrated in FIG. 3 as an example. Exemplary changes to shield 105 sufficient to vary the amount of heat energy reflected are: thickness, distance from the food and heating elements, material, and coatings, to name a few. It is understood that these factors are not exhaustive.

In operation, a user obtains a selected device 101 to match the relative size and shape of the food. The food is placed partially under a heat shield 105. The food and device 101 are placed in the heating cooking device and subjected to a predetermined level of heat for a particular time duration. The user then removes the food and/or the device 101 when the heating is finished. The food is then optionally removed from the device 101.

Other steps may also involve instances where shield 105 are interchangeable. A user may select a suitable shield 105 to have the properties and shape desired for a particular food. The shields may be interchanged as desired. Additionally, with any of the above embodiments, the user may elect to modify the contour of shield 105 so as to provide the desired effect upon the food.

The current application has many advantages over the prior art including at least the following: (1) a device and method for evenly cooking or heating food in a cooking device; (2) a heat shield for reflecting levels of heat energy; and (3) avoidance of burning portions of food located more closely to a heating element of the cooking device.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A protection device for food, comprising:
a lower member configured to provide support and elevation; and
a heat shield in communication with and integrally formed into the lower member, the heat shield configured to reflect heat, the heat shield being C-shaped having a continuously curved contour folding over itself so as to extend over a portion of the lower member and a portion of itself adjacent the lower member;
wherein the heat shield regulates the amount of heat applied directly to the food between the heat shield and the lower member.

2. The protection device of claim 1, wherein the lower member includes one or more apertures.

3. The protection device of claim 1, wherein the lower member is a mesh.

4. The protection device of claim 1, wherein the lower member is formed in the shape of a triangle.

5-7. (canceled)

8. A method of heating food, comprising:
obtaining a food protection device having:
a lower member configured to provide support and elevation; and
a heat shield in communication with and integrally formed into the lower member, the heat shield configured to reflect heat, the heat shield being C-shaped having a continuously curved contour folding over itself so as to extend over a portion of the lower member and a portion of itself adjacent the lower member;
wherein the heat shield regulates the amount of heat applied directly to the food between the heat shield and the lower member;
placing food on the lower member;
locating a portion of the food both above and beneath the heat shield; and
subjecting the food and the protection device to a predetermined level of heat for a particular time duration.

9. The method of claim 8, further comprising:
removing the protection device from the heat.

10. The method of claim 8, further comprising:
removing the food from the protection device without removing the heat shield from the lower member.

11. The method of claim 8, further comprising:
adjusting the contour of the heat shield.
